(19) United States
(12) Patent Application Publication
(10) Pub. No.: US 2013/0257919 A1
(43) Pub. Date: Oct. 3, 2013

(54) IMAGE DISPLAY APPARATUS AND CONTROL METHOD THEREFOR

(71) Applicant: CANON KABUSHIKI KAISHA, Tokyo (JP)

(72) Inventors: Takushi Kimura, Kawasaki-shi (JP); Takeshi Ikeda, Ebina-shi (JP)

(73) Assignee: CANON KABUSHIKI KAISHA, Tokyo (JP)

(21) Appl. No.: 13/797,261

(22) Filed: Mar. 12, 2013

(30) Foreign Application Priority Data
Mar. 30, 2012 (JP) 2012-081183

(51) Int. Cl. G09G 5/10

(52) U.S. Cl. CPC G09G 5/10; G09G 3/36
USPC 345/690; 345/102

(57) ABSTRACT

An image display apparatus of the invention includes a storage unit that stores representative point brightness data, which is data of brightnesses in predetermined representative points at the time when only one each of a plurality of light emission blocks is caused to emit light, and brightness distribution data, which is data showing a brightness distribution in individual positions between representative points at the time when only the one light emission block is caused to emit light. An amount of correction corresponding to each representative point is calculated based on an amount of light emission for each light emission block, and representative point brightness data, and an amount of correction for correcting a pixel value of each of pixels other than those at the representative points is calculated based on the amount of correction corresponding to each representative point, and the brightness distribution data.

### BACKGROUND OF THE INVENTION

1. Field of the Invention

The present invention relates to an image display apparatus and a control method therefor.

2. Description of the Related Art

In liquid crystal display devices, there is a brightness (luminance) control technique that is provided with a backlight apparatus (lighting apparatus) composed of a plurality of light emission blocks, the brightnesses of which are able to be controlled independently of one another, wherein the display area of a liquid crystal panel is divided into a plurality of division areas corresponding to the individual light emission blocks of the backlight apparatus, so that brightness (luminance) is controlled for each of the light emission blocks based on image signals. By carrying out image processing on the image signals which correspond to the individual divided areas, respectively, based on the brightnesses of the individual light emission blocks, thereby to control the transmittance of the liquid crystal panel, there can be obtained such effects as an improvement in contrast and a reduction in power consumption. In such backlight brightness or brightness control, in order to display an image in an appropriate manner, it is necessary to estimate the brightness of a backlight illuminated on each pixel in an accurate manner, and to control the transmittance of a corresponding liquid crystal cell based on the brightness thus estimated.

In the past, as a method of estimating the brightness of the backlight which illuminates each pixel, there has been a method of estimating the brightness for each pixel by storing in advance data which shows the pixel by pixel distribution of the brightness at the time when each light emission block is lit, and then superposing them with each other. (For example, refer to Japanese patent application laid-open No. 2008-304908.)

In addition, there has also been a method of first estimating the brightness of a backlight for each light emission block, and then estimating the brightness for each pixel by carrying out linear interpolation of adjacent light emission blocks. (For example, refer to Japanese patent application laid-open No. 2009-192963.)

### SUMMARY OF THE INVENTION

In the technique of the above-mentioned Japanese patent application laid-open No. 2008-304908, however, a number of brightness distribution data, which is proportional to the number of the light emission blocks of the backlight, and which corresponds to the individual pixels is required, and hence, it is necessary to store a large amount of data in advance. In addition, in the calculation operation of the brightness estimation, there is a need to carry out the same number of weighted summations of the brightness distribution data as that of the light emission blocks of the backlight. For that reason, in cases where the number of the light emission blocks of the backlight is large, there has been a problem that the amount of data and the amount of calculation or computation become huge.

In addition, in the technique of the above-mentioned Japanese patent application laid-open No. 2009-192963, the brightness of the backlight is estimated per light emission block, so the amount of calculation operation is small, but the brightness distribution of the backlight is not flat, and hence, an error in the estimated brightness for each pixel obtained by the linear interpolation is large. For that reason, there has been a problem that an image, which is displayed by controlling the transmittance of each liquid crystal cell based on the estimated brightness, has a large distortion from an intended image, and its image quality deteriorates to a large extent.

Accordingly, the present invention has for its object to provide a technique in which in a transmission type image display apparatus provided with a lighting apparatus composed of a plurality of light emission blocks, the brightnesses of which can be controlled independently of one another, it is possible to suppress the deterioration in quality of a display image, while suppressing an amount of estimation operation or calculation for each pixel of lighting brightness by the lighting apparatus.

A first aspect of the present invention resides in an image display apparatus which comprises:

a lighting apparatus composed of a plurality of light emission blocks, the emissions of lights of which are able to be controlled independently of one another;

a display panel configured to control the transmittances of the lights from said lighting apparatus for each pixel;

a first calculation unit configured to calculate an amount of light emission for each light emission block based on an image signal;

a storage unit configured to store representative point brightness (luminance) data, which is data of brightnesses in a plurality of representative points provided in each of said plurality of light emission blocks at the time when only one of said light emission blocks is caused to emit light with a predetermined amount of light emission, in cases where each of said plurality of light emission blocks is caused to emit light, and at the same time to store brightness distribution data which is data showing brightness distribution in individual positions between mutually adjacent representative points of the one of said light emission blocks at the time when only the one of said light emission blocks is caused to emit light with the predetermined amount of light emission;

a second calculation unit configured to calculate an amount of correction for correcting a pixel value of a pixel in each of positions which correspond to the individual representative points of said plurality of light emission blocks, respectively, based on the amount of light emission for each of said light emission blocks and the representative point brightness data of said plurality of light emission blocks, and at the same time to calculate an amount of correction for correcting a pixel value of each of pixels other than those at said representative points based on the amount of correction for correcting the pixel value of the pixel in each of the positions which correspond to the individual representative points, respectively, and said brightness distribution data; and

a correction unit configured to output to said display panel a correction image signal in which a pixel value of each pixel of an image signal inputted thereto is corrected by the use of the amount of correction calculated by said second calculation unit.

A second aspect of the present invention resides in a control method for an image display apparatus which includes:

a lighting apparatus composed of a plurality of light emission blocks, the emissions of lights of which are able to be controlled independently of one another; and

a display panel configured to control the transmittances of the lights from said lighting apparatus for each pixel;

wherein said control method comprises:

a first calculation step to calculate an amount of light emission for each light emission block based on an image signal;

a step to read in representative point brightness data and brightness distribution data from a storage unit which is configured to store the representative point brightness data, which is data of brightnesses in predetermined representative points provided in each of said plurality of light emission blocks at the time when only one of said light emission blocks is caused to emit light with a predetermined amount of light emission, in cases where each of said plurality of light emission blocks is caused to emit light, and which is also configured to store the brightness distribution data which is data showing brightness distribution in individual positions between mutually adjacent representative points of the one of said light emission blocks at the time when only the one of said light emission blocks is caused to emit light with the predetermined amount of light emission;

a second calculation step to calculate an amount of correction for correcting a pixel value of a pixel in each of positions which correspond to the individual representative points of said plurality of light emission blocks, respectively, based on the amount of light emission for each of said light emission blocks and the representative point brightness data of said plurality of light emission blocks, and at the same time to calculate an amount of correction for correcting a pixel value of each of pixels other than those at said representative points based on the amount of correction for correcting the pixel value of the pixel in each of the positions which correspond to the individual representative points, respectively, and said brightness distribution data; and

a correction step to output to said display panel a correction image signal in which a pixel value of each pixel of an image signal inputted thereto is corrected by the use of the amount of correction calculated in said second calculation step.

According to the present invention, in a transmission type image display apparatus provided with a lighting apparatus that is composed of a plurality of light emission blocks, the brightnesses of which are able to be controlled independently of one another, it is possible to suppress a deterioration in display image quality, while suppressing an amount of estimation calculation for each pixel of lighting brightness by the lighting apparatus.

Further features of the present invention will become apparent from the following description of exemplary embodiments with reference to the attached drawings.

### BRIEF DESCRIPTION OF THE DRAWINGS

FIG. 1 is a view showing an example of the functional construction of an image processing apparatus according to a first, a second and a third embodiment of the present invention.

FIG. 2 is a view explaining the relation between distributions of lighting brightness and the positions of representative points.

FIG. 3 is a view explaining the relation between light emission blocks and the representative points according to the first embodiment of the present invention.

FIG. 4 is a flow chart of lighting brightness calculation processing.

FIG. 5 is a view explaining the relation among the light emission blocks, the representative points and correction points according to the first embodiment of the present invention.

FIG. 6 is a view showing an example of the functional construction of an image correction unit according to the first and third embodiments of the present invention.

FIG. 7 is a view explaining the relation between relative positions of pixels to be noted and expansion rate data thereof according to the first embodiment of the present invention.

FIG. 8 is a view explaining interpolation processing according to the first embodiment of the present invention.

FIG. 9 is a view showing an example of the functional construction of an image correction unit according to the second embodiment of the present invention.

FIG. 10 is a view explaining interpolation processing according to the second embodiment of the present invention.

FIG. 11 is a view explaining the relation between representative points and correction points according to the third embodiment of the present invention.

FIG. 12 is a view explaining the relation between relative positions of pixels to be noted and expansion rate data thereof according to the third embodiment of the present invention.

### DESCRIPTION OF THE EMBODIMENTS

### First Embodiment

Hereinafter, an image display apparatus and a control method therefor according to a first embodiment of the present invention will be described with reference to the accompanying drawings.

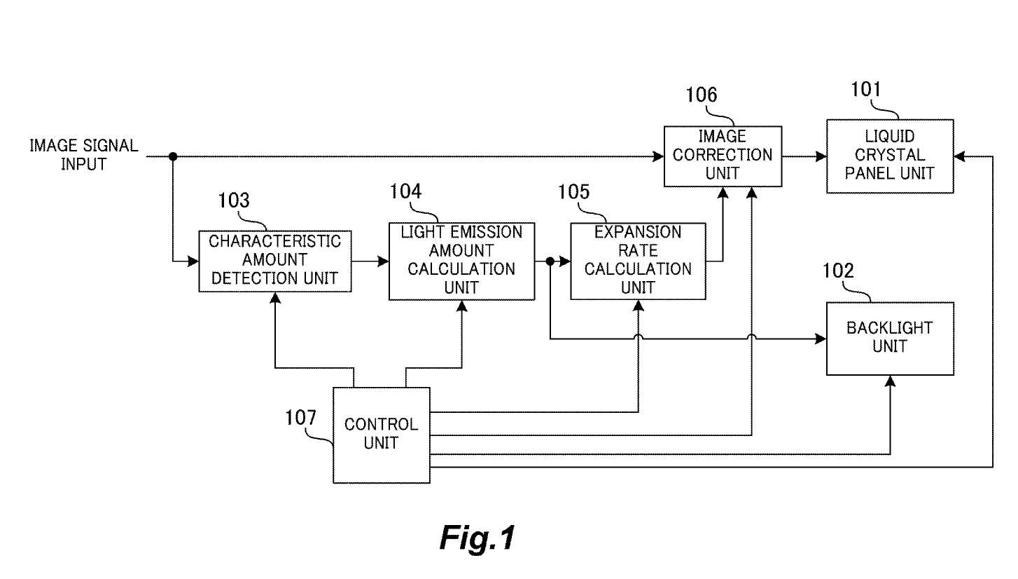

FIG. 1 is a view showing the functional construction of an image processing apparatus according to the first embodiment of the present invention.

The image display apparatus is comprised of a liquid crystal panel unit 101, a backlight unit 102, a characteristic amount detection unit 103, a light emission amount calculation unit 104 (first calculation unit), an expansion rate calculation unit 105 (second calculation unit), an image correction unit 106, and a control unit 117. The control unit 117 is a functional part which carries out the control of the operations of individual functional units to be described later.

The liquid crystal panel unit 101 is a transmission type display panel which controls liquid crystal cells based on an image signal inputted to the liquid crystal panel unit 101, thereby controlling the transmittance of each pixel.

The backlight unit 102 is a lighting apparatus (i.e., a backlight apparatus) which has a plurality of light emission blocks, the brightnesses (luminance) of which are able to be controlled independently of one another, and which illuminates the liquid crystal panel unit 101. The illumination or lighting brightness of each of the light emission blocks is controlled based on the control value of the amount of light emission. For example, the backlight unit 102 is composed of a total of m×n light emission blocks which are obtained by dividing a lighting range into m pieces in the horizontal direction and into n pieces in the vertical direction, and the amounts of light emission of those light emission blocks are controlled independently of one another.

Here, note that the present invention is able to be applied to other lighting apparatus than a backlight apparatus of a liquid crystal display device. In addition, the image display apparatus according to the present invention is not limited to a liquid crystal display device provided with a liquid crystal panel as a display panel.

In the backlight brightness control of the present embodiment, the display area of the liquid crystal panel unit 101 is divided into divided areas which correspond to the individual light emission blocks of the backlight unit 102, respectively, and the brightness of a light emission block corresponding to each of the divided areas is controlled according to an image signal corresponding to an image displayed on each of the divided areas. Then, according to the brightness of each light emission block, image processing is carried out with respect to the image signal of each corresponding divided area. Such control is referred to as local dimming control.

By carrying out the local dimming control, for example, the brightness of a light emission block corresponding to a divided area with a dark image being displayed therein is suppressed, and image processing to expand pixel values is carried out with respect to an image signal of the divided area concerned, thereby making it possible to enhance the transmittance of the liquid crystal panel in the divided area concerned. As a result of this, it becomes possible to mitigate the misadjusted black level of the dark image as well as to decrease the electric power consumption of the backlight apparatus, without reducing the display brightness of the liquid crystal panel in the divided area concerned. Here, note that the divided areas of the liquid crystal panel and the light emission blocks of the backlight do not need to correspond to each other in a one to one relation. In this embodiment, however, in order to simplify the description, it is assumed that the individual divided areas of the liquid crystal panel and the individual light emission blocks of the backlight correspond to each other in a one to one relation.

The characteristic amount detection unit 103 divides the inputted image signal by the plurality of divided areas, and detects a characteristic amount of the image signal for each of the divided areas. In this embodiment, the characteristic amount detection unit 103 detects, as a characteristic amount, a maximum value of the pixel values (hereinafter also referred to as a maximum pixel value) of the image signal in each of the divided areas. The maximum pixel value thus detected is outputted to the light emission amount calculation unit 104.

The light emission amount calculation unit 104 calculates and outputs a suppression rate of the amount of light emission and a control value of the amount of light emission for each light emission block, based on a characteristic amount (here, a maximum pixel value) for each divided area detected by the characteristic amount detection unit 103. The suppression rate of the amount of light emission is a ratio of the amount of light emission with respect to the largest possible amount of light emission. As mentioned above, in the local dimming control, the enhancement of contrast and the reduction of the electric power consumption are intended by decreasing the amount of light emission of the light emission block which corresponds to the divided area where the dark image is displayed, wherein the suppression rate of the amount of light emission indicates an extent to which this amount of light emission is decreased. In order to display all the pixels of the divided area at brightness levels which correspond to their pixel values, respectively, the lighting brightness of a light emission block corresponding to the divided area should just be set in such a manner that a pixel of a maximum pixel value among the pixels in the divided area can be displayed at a brightness level which is assumed with that pixel value.

Accordingly, the light emission amount calculation unit 104 calculates a target value of lighting brightness (target lighting brightness) for each light emission block by multiplying a standard lighting brightness (standard lighting luminance) by the ratio of the maximum pixel value in the divided area with respect to a maximum gradation value (i.e., a fixed value, for example, 256 for 8 bits). Here, the standard lighting brightness indicates a lighting brightness of the backlight in cases where image display is carried out, without performing the local dimming control (i.e., suppression of the brightness for each light emission block, and expansion of the pixel values for each divided area). The standard lighting brightness is taken as the largest possible lighting brightness with the backlight unit 102, for example. Because the amount of light emission of each light emission block is affected by the influence of the light emission of light sources which belong to other light emission blocks, it is necessary to decide the control value of the amount of light emission in consideration of the influence of all the light emission blocks. Accordingly, the light emission amount calculation unit 104 calculates the control value of the amount of light emission for each light emission block in the following manner.

First, in order to control the lighting brightness of each light emission block to a brightness level at which a maximum pixel value in a divided area corresponding to that light emission block can be displayed, the light emission amount calculation unit 104 calculates a temporary suppression rate by dividing the maximum pixel value by the maximum gradation value, for each light emission block. Then, the light emission amount calculation unit 104 calculates a target lighting brightness of each light emission block by multiplying the temporary suppression rate therefor to the standard lighting brightness. Thereafter, the light emission amount calculation unit 104 calculates a temporary estimated brightness (estimated luminance), which is an estimated value of a brightness at a predetermined representative point within the display area of the liquid crystal panel, by carrying out the weighted summation of representative point brightness data (representative luminance data) for the individual light emission blocks, which have been stored in advance, while being weighted by the temporary suppression rates, respectively.

The representative point brightness data are stored for each of the light emission blocks, and the representative point brightness data of a certain light emission block contain information on brightness for each representative point at the time of causing that light emission block to emit light at the standard lighting brightness. The representative point brightness data of this embodiment is composed of information on the brightnesses of only the representative points, instead of information on the brightnesses of all the pixels, so the amount (or volume) of the data required becomes small. The brightness for each of the representative points has been obtained in advance by measurement or calculation, and has been stored in a storage unit as representative point brightness data.

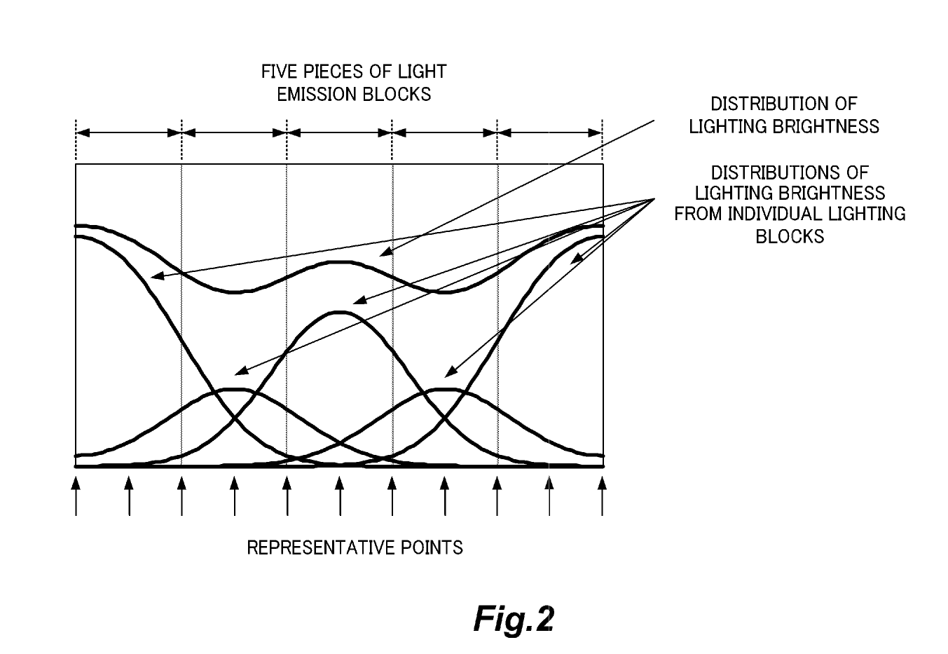

As a representative point (a first representative point), it is desirable to select a point at which a distribution of the lighting brightness becomes a crest (or a mountain top) or a trough bottom (or a valley bottom), or select an inflection point of a brightness distribution curve, or a point in the vicinity of these points. This is because such a representative point becomes a reference at the time of calculating an expansion rate or elongation percentage as an amount of correction for correcting a pixel value at a point in an arbitrary position (details thereof will be described later). For example, in this embodiment, let a point of the center of each light emission block and points on boundaries between adjacent light emission blocks be representative points. A view explaining the relation between distributions of lighting brightness and the positions of representative points is shown in FIG. 2.

FIG. 2 schematically shows five light emission blocks in one dimension, and at the same time, schematically shows brightness distributions according to the light emission of the individual five light emission blocks, respectively, and a brightness distribution according to the entire five light emission blocks obtained by superposing the five brightness distributions on one another. As shown in FIG. 2, the individual light emission block brightness distributions become curves in which the brightness of each block has a peak at the center point of each light emission block and decreases in accordance with the distance from the center point. FIG. 2 shows an example in which the center point of each of the light emission blocks, and boundary points between the adjacent light emission blocks, are made as representative points.

As shown in FIG. 2, it can be understood that by selecting the representative points in this manner, those points at which each distribution of lighting brightness has a crest or a bottom, or those points at which each distribution curve of lighting brightness has an inflection point, are made as the representative points. The brightness distribution of each light emission block is shown by a continuous curve in FIG. 2, but in this embodiment, only the brightnesses at the representative points have been stored in advance in the storage unit as representative point brightness data. That is, in this embodiment, the amount of data can be suppressed by holding discrete representative point brightness data for each light emission block.

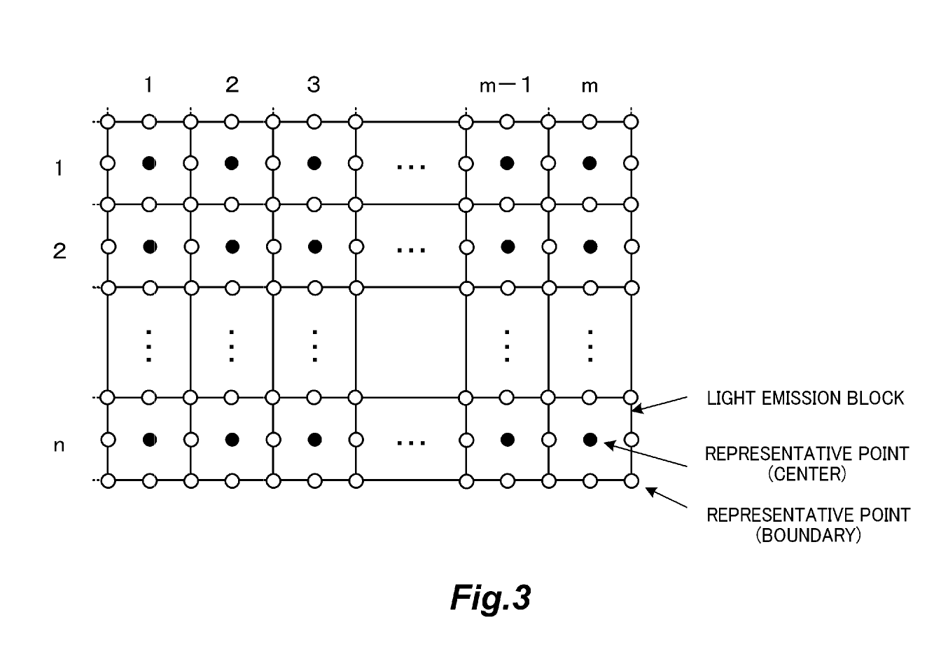

In this embodiment, by enlarging such a point of view to two dimensions, there is shown an example which has, as representative points, a total of nine points for each light emission block, including a point of the center of each light emission block, four vertices at four corners of the boundaries between adjacent light emission blocks, and four halfway points on the four sides of each light emission block. A view explaining the positional relation of the light emission blocks and the representative points is shown in FIG. 3. In an example of FIG. 3, in cases where the backlight has a total of m×n light emission blocks including m pieces in the horizontal direction and n pieces in the vertical direction, the number of the representative points becomes a sum total of (2×m+1)×(2×n+1). Here, note that the representative point brightness data for the individual light emission blocks having been stored in advance in the storage unit should just be data of brightnesses corresponding to the positions of the (2×m+1)×(2×n+1) representative points, and hence, there is no need to store data of brightnesses corresponding to all the pixel positions. As a result of this, the amount of data for the representative point brightness data can be suppressed. Although in the example of FIG. 3, the shape of each light emission block is square, the light emission blocks may each have a rectangular shape.

When the backlight is caused to emit light based on the temporary suppression rate, a light emission block having an insufficient lighting brightness may Occur. In addition, on the contrary, the lighting brightness of a certain light emission block may become surplus. The insufficient lighting brightness of a light emission block indicates that the lighting brightness obtained at a pixel having a maximum pixel value within a divided area corresponding to that light emission block is lower with respect to a lighting brightness which is required in order to display the pixel at a brightness originally assumed.

Accordingly, the light emission amount calculation unit 104 decides a suppression rate in such a manner that any light emission block having an insufficient lighting brightness does not occur. Specifically, the light emission amount calculation unit 104 calculates the ratio of a temporary estimated brightness with respect to a target lighting brightness for all the representative points, and sets the smallest one among those thus calculated as a minimum brightness ratio (minimum luminance ratio). Then, the light emission amount calculation unit 104 calculates a corrected suppression rate for each light emission block by dividing the temporary suppression rate for each light emission block by the minimum brightness ratio. A control value for the amount of light emission becomes a value which is obtained by multiplying a control value for the standard lighting brightness by the corrected suppression rate thus obtained.

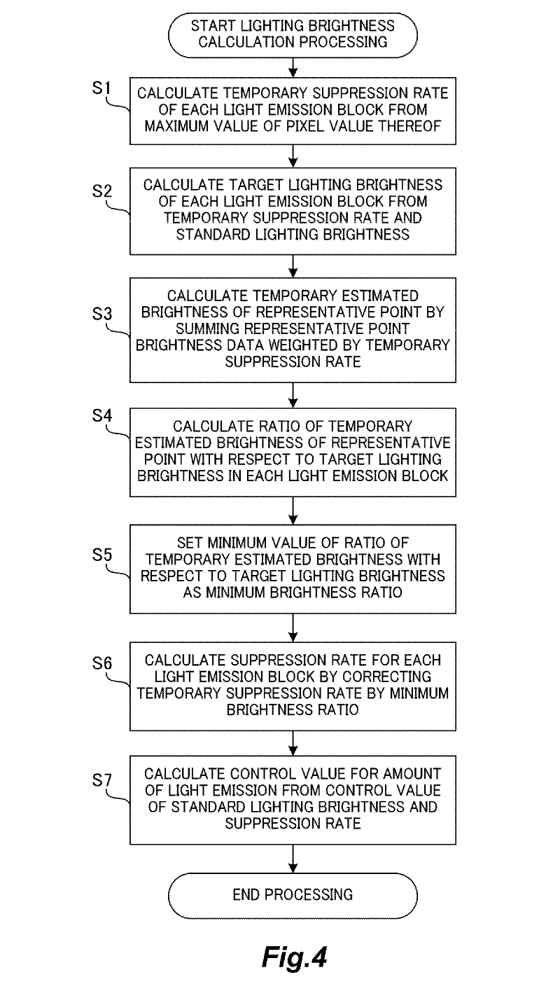

Here, reference will be made to a flow which calculates the suppression rate of the amount of light emission for each light emission block and the control value of the amount of light emission, while using a flow chart of FIG. 4. The processing of this flowchart is carried out by the light emission amount calculation unit 104.

In step 1, the light emission amount calculation unit 104 calculates a temporary suppression rate for each light emission block by dividing a maximum pixel value in a corresponding divided area by the maximum gradation value.

In step 2, the light emission amount calculation unit 104 calculates a target lighting brightness for each light emission block by multiplying the standard lighting brightness by a temporary suppression rate therein.

In step 3, the light emission amount calculation unit 104 calculates a temporary estimated brightness at a predetermined representative point within the screen or display area of the liquid crystal panel, by reading out from the storage unit representative point brightness data for the individual light emission blocks, which have been stored in advance, and summing the thus read out data, while weighting them by the temporary suppression rates, respectively.

In step 4, the light emission amount calculation unit 104 calculates the ratio of a temporary estimated brightness at a representative point with respect to its target lighting brightness for all the representative points.

In step 5, the light emission amount calculation unit 104 sets a minimum value among the ratios of the temporary estimated brightnesses with respect to their target brightnesses as a minimum brightness ratio.

In step 6, the light emission amount calculation unit 104 calculates a suppression rate for each light emission block by dividing the temporary suppression rate for each light emission block by the minimum brightness ratio.

In step 7, the light emission amount calculation unit 104 calculates a control value of the amount of light emission for each light emission block by multiplying a control value of the standard lighting brightness by the corresponding suppression rate.

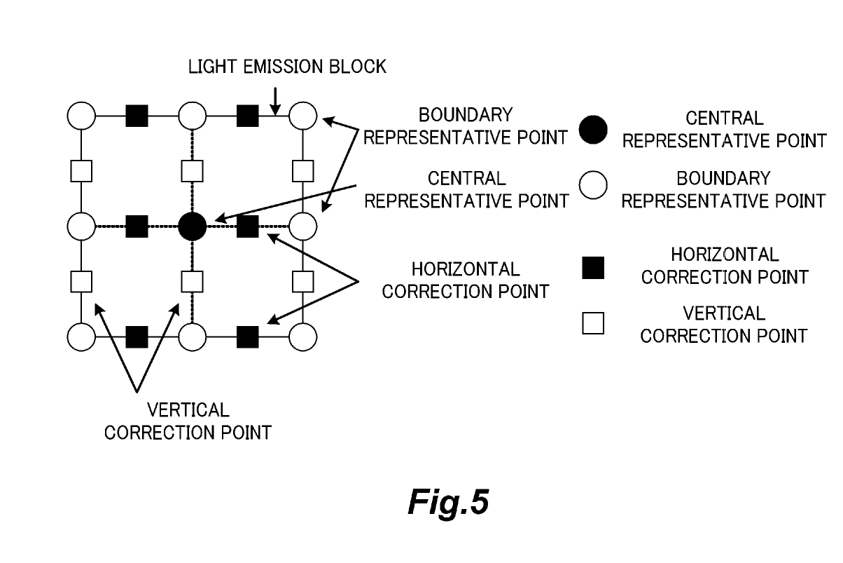

The expansion rate calculation unit 105 carries out correction amount calculation for correcting the pixel value of each pixel. That is, the expansion rate calculation unit 105 calculates an expansion rate of the pixel value of each representative point, and an expansion rate of the pixel value of each correction point, based on the suppression rate of the amount of light emission for each light emission block calculated by the light emission amount calculation unit 104, and the representative point brightness data stored in advance. Each of the correction points is a second representative point which is arranged between adjacent representative points in order to carry out nonlinear interpolation of the expansion rates of the representative points. Then, the expansion rate calculation unit 105 outputs the representative point expansion rate data thus obtained which correspond to the individual representative points, respectively, and curve expansion rate data which correspond to the individual correction points, respectively. The curve expansion rate data are the values which are each calculated from an expansion rate which corresponds to each correction point, and an expansion rate which corresponds to each representative point (to be described later). A view explaining the positional relation of the light emission blocks, the representative points and the correction points is shown in FIG. 5.

In FIG. 5, a representative point at the center of each light emission block is represented as a central representative point, and representative points at the four corners of each light emission block as well as representative points at the centers of the four sides of each light emission block are represented as boundary representative points. In addition, a correction point located at the center of two representative points which are adjacent to each other in the longitudinal or vertical direction is represented as a vertical correction point, and a correction point located at the center of two representative points which are adjacent to each other in the lateral or horizontal direction is represented as a horizontal correction point. In cases where a whole light emission block unit is divided into m×n pieces of individual light emission blocks, the number of representative points is (2×m+1)×(2×n+1), and the number of correction points is (8×m×n+2×m+2×n). In this embodiment, the representative point brightness data for each light emission block stored in advance are composed of data of the brightnesses at all the representative points and correction points therein. Thus, the data stored are data of the brightnesses at the discrete positions, instead of data of the brightnesses at all the pixels, and hence, there is a small amount of data required for the representative point brightness data.

Similarly to the processing explained in the operation of the light emission amount calculation unit 104, the expansion rate calculation unit 105 calculates the estimated brightness of each representative point and that of each correction point by summing the representative point brightness data stored in advance, while weighting them by their suppression rates, respectively. Subsequently, the expansion rate calculation unit 105 calculates the expansion rate of the pixel value of each representative point and that of each correction point by dividing the standard lighting brightness by the estimated brightnesses thus obtained, respectively. Then, the expansion rate calculation unit 105 outputs the expansion rate of each representative point thus calculated as representative point expansion rate data.

In addition, the expansion rate calculation unit 105 outputs a difference between the calculated expansion rate of each correction point and an average value of the expansion rates of two representative points which are adjacent to the correction point, as curve expansion rate data of each correction point. When the expansion rate of a correction point is represented by GC and the expansion rates of two representative points adjacent to the correction point are represented by GP1 and GP2, respectively, a corresponding curve expansion rate data CG is calculated by the following expression. Here, note that a curve expansion rate of a horizontal correction point is referred to as a horizontal curve expansion rate, and a curve expansion rate of a vertical correction point is referred to as a vertical curve expansion rate.

CG=GC−(GP1+GP2)/2 (1)

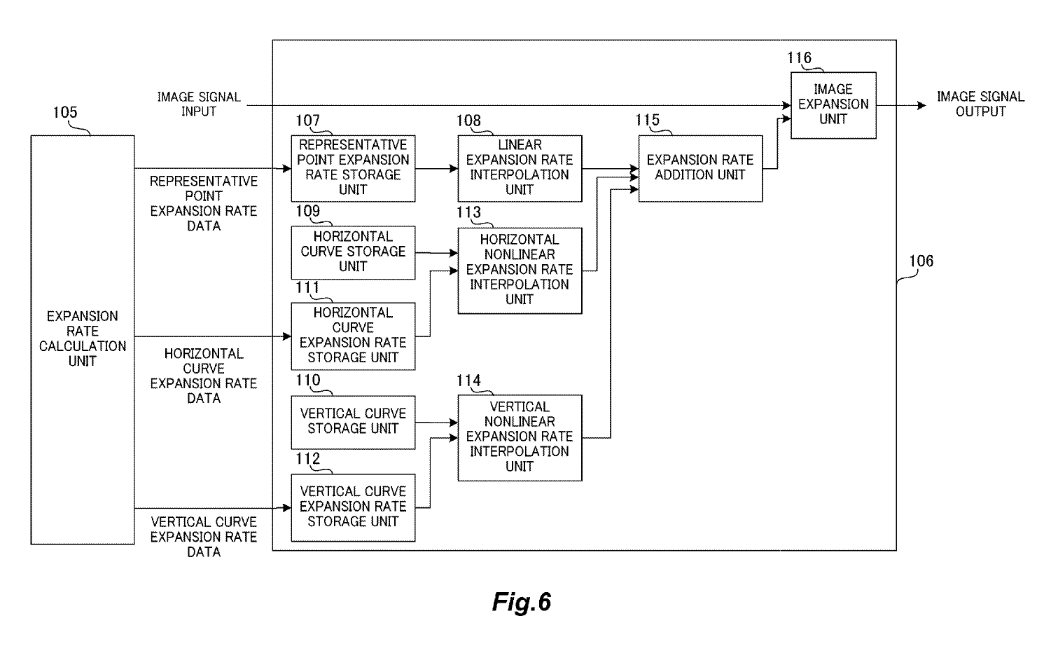

The image correction unit 106 outputs an expanded image signal (corrected image signal) in which the pixel value of each pixel of an inputted image signal is expanded based on the representative point expansion rate data and the curve expansion rate data calculated by the expansion rate calculation unit 105. An example of the functional configuration of the image correction unit 106 is shown in FIG. 6.

The image correction unit 106 is composed of a representative point expansion rate storage unit 107, a linear expansion rate interpolation unit 108, a horizontal curve storage unit 109, a vertical curve storage unit 110, a horizontal curve expansion rate storage unit 111, a vertical curve expansion rate storage unit 112, a horizontal nonlinear expansion rate interpolation unit 113, a vertical nonlinear expansion rate interpolation unit 114, an expansion rate addition unit 115, and an image expansion unit 116.

The representative point expansion rate storage unit 107 stores the expansion rate of each representative point as representative point expansion rate data. Then, the representative point expansion rate storage unit 107 outputs, based on the position of a pixel of interest (a target pixel, of which the expansion rate is calculated), representative point expansion rate data of four representative points surrounding that pixel.

The linear expansion rate interpolation unit 108 calculates and outputs a linear expansion rate by performing a linear interpolation operation of the four pieces of representative point expansion rate data outputted from the representative point expansion rate storage unit 107 based on the relative positional relation of the pixel of interest with respect to the four representative points surrounding the pixel of interest. Specifically, when the number of horizontal pixels from the central representative point to the pixel of interest is represented by DPh, the number of vertical pixels is represented by DPv, the number of pixels between representative points in the horizontal direction is represented by PWh, and the number of pixels between representative points in the vertical direction is represented by PWv, the linear expansion rate interpolation unit 108 obtains a linear expansion rate Gln of the pixel of interest according to the following expression.

Gln=(1−DPv/PWv)×((1−DPh/PWh)×Gc+DPh/PWh×Gh)+(DPv/PWv)×((1−DPh/PWh)×Gv+DPh/PWh×Ghv) (2)

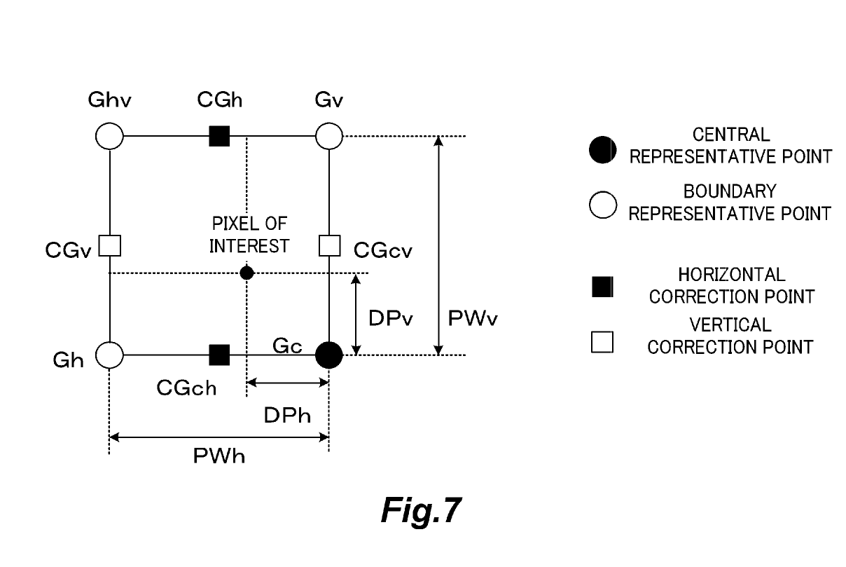

Here, Gc is the representative point expansion rate data of the central representative point, and Gh is the representative point expansion rate data of a boundary representative point which is adjacent to the central representative point in the horizontal direction. In addition, Gv is the representative point expansion rate data of a boundary representative point which is adjacent to the central representative point in the vertical direction, and Ghv is the representative point expansion rate data of a boundary representative point which is adjacent to the central representative point in an oblique direction therefrom. A view explaining the relative positions of the pixel of interest and the four representative points surrounding it and the relation of the expansion rate data thereof is shown in FIG. 7.

The horizontal curve storage unit 109 stores data (i.e., brightness distribution data (luminance distribution data)) of nonlinear curves (i.e., referred to as horizontal curves), each of which approximately shows a horizontal shape of a brightness distribution between the representative points which are adjacent to each other in the horizontal direction. The horizontal curve is obtained as follows, based on a brightness distribution at the time of causing one of the light emission blocks to emit light, for example. That is, the horizontal curve is assumed to be a difference between a brightness distribution shape (generally a nonlinear distribution) from the central representative point to the boundary representative point which is adjacent to it in the horizontal direction, and a brightness distribution shape (linear) in cases where it is assumed that a brightness distribution curve from the brightness at the central representative point to the brightness at the boundary representative point changes in a linear manner.

The horizontal curve shows a brightness distribution shape for the value of this difference from the central representative point to the boundary representative point. That is, the horizontal curve is a function in which the values for individual points (pixels) from the central representative point to the boundary representative point adjacent to it in the horizontal direction are fixed, and the horizontal curve can be represented as a function of the number of pixels from the central representative point. The value of the horizontal curve obtained in this manner becomes zero at the boundary representative point and at the central representative point. In cases where the brightness distribution shape from the central representative point to the boundary representative point is always convex, the value of the horizontal curve takes a positive value at individual points therebetween, whereas in cases where the brightness distribution shape between the central and boundary representative points is always downwardly convex (i.e., concave), the value of the horizontal curve takes a negative value at the individual points therebetween.

The horizontal curve can have data of values in all the positions from the central representative point to the boundary representative point, and can be represented, for example, as a function of the number of pixels DPh from the central representative point. In this embodiment, it is assumed that the horizontal curve, which has been normalized so that the value of the horizontal curve at the horizontal correction point between the central representative point and the boundary representative point becomes one, has been stored in the horizontal curve storage unit 109. Then, the horizontal curve storage unit 109 outputs horizontal curve data based on the position of the pixel of interest and the horizontal relative positions of two representative points which are adjacent to the pixel of interest in the horizontal direction.

The horizontal curve expansion rate storage unit 111 stores the curve expansion rate data of the horizontal correction point. Then, the horizontal curve expansion rate storage unit 111 outputs the curve expansion rate data of two horizontal correction points adjacent to the pixel of interest, based on the position of the pixel of interest. Here, the two horizontal correction points adjacent to the pixel of interest are a horizontal correction point between the central representative point and the boundary representative point which is adjacent to it in the horizontal direction, and a horizontal correction point between two boundary representative points other than those (above two) representative points, among the four representative points surrounding the pixel of interest.

The horizontal nonlinear expansion rate interpolation unit 113 carries out linear interpolation of the horizontal curve expansion rate data of the two horizontal correction points outputted from the horizontal curve expansion rate storage unit 111 based on the vertical relative position of the pixel of interest with respect to the central representative point. Then, the horizontal nonlinear expansion rate interpolation unit 113 multiplies the horizontal curve data outputted from the horizontal curve storage unit 109 by the horizontal curve expansion rate data thus interpolated, and outputs it as a horizontal nonlinear expansion rate. The horizontal curve data corresponds to a nonlinear brightness distribution, and so, here, a nonlinear interpolation operation is carried out by the calculation operation of multiplying the horizontal curve data by the horizontal curve expansion rate data. Specifically, when the number of vertical pixels from the central representative point to the pixel of interest is represented by DPv, the number of pixels between representative points in the vertical direction is represented by PWv, and the horizontal curve data is represented by CVh, the horizontal nonlinear expansion rate Gnlh is obtained from the following expression.

Gnlh=CVh×((1−DPv/PWv)×CGch+DPv/PWv×CGh) (3)

Here, as shown in FIG. 7, CGch is the curve expansion rate data of a horizontal correction point between the central representative point and a boundary representative point which are adjacent to each other in the horizontal direction, and CGh is the curve expansion rate data of a horizontal correction point between a boundary representative point and a boundary representative point which are adjacent to each other in the horizontal direction.

The vertical curve storage unit 110 stores data of nonlinear curves (i.e., referred to as vertical curves), each of which approximately shows a vertical shape of a brightness change between the representative points which are adjacent to each other in the vertical direction. The basic operation of the vertical curve storage unit 110 is the same as that of the horizontal curve storage unit 109. In addition, in cases where the nonlinear curve in the horizontal direction may be the same as that in the vertical direction, the horizontal curve storage unit 109 and the vertical curve storage unit 110 may be made in common with each other.

The vertical curve expansion rate storage unit 112 stores the curve expansion rate data of the vertical correction point. The basic operation of the vertical curve expansion rate storage unit 112 is the same as that of the horizontal curve expansion rate storage unit 111.

The vertical nonlinear expansion rate interpolation unit 114 carries out linear interpolation of the vertical curve expansion rate data of the two vertical correction points outputted from the vertical curve expansion rate storage unit 112 based on the horizontal relative position of the pixel of interest with respect to the central representative point. Then, the vertical nonlinear expansion rate interpolation unit 114 multiplies the vertical curve data outputted from the vertical curve storage unit 110 by the vertical curve expansion rate data thus interpolated, and outputs it as a vertical nonlinear expansion rate. Specifically, when the number of horizontal pixels from the central representative point to the pixel of interest is represented by DPh, the number of pixels between representative points in the horizontal direction is represented by PWh, and the vertical curve data is represented by CVv, the vertical nonlinear expansion rate Gnlv is obtained from the following expression.

Gnlv=CVv×((1−DPh/PWh)×CGcv+DPh/PWh×CGv) (4)

Here, as shown in FIG. 7, CGcv is the curve expansion rate data of a vertical correction point between the central representative point and a boundary representative point which are adjacent to each other in the vertical direction, and CGv is the curve expansion rate data of a vertical correction point between a boundary representative point and a boundary representative point which are adjacent to each other in the vertical direction.

The expansion rate addition unit 115 adds the linear expansion rate Gln outputted from the linear expansion rate interpolation unit 108, the horizontal nonlinear expansion rate Gnlh outputted from the horizontal nonlinear expansion rate interpolation unit 113, and the vertical nonlinear expansion rate Gnlv outputted from the vertical nonlinear expansion rate interpolation unit 114 to one another. As a result of this, the expansion rate addition unit 115 calculates and outputs an expansion rate Gpix for each pixel. Specifically, the expansion rate Gpix for each pixel is obtained by the following expression.

Gpix=Gln+Gnlh+Gnlv (5)

The image expansion unit 116 corrects the image signal by multiplying each pixel value of the image signal by the expansion rate for each pixel, and outputs the image signal thus corrected.

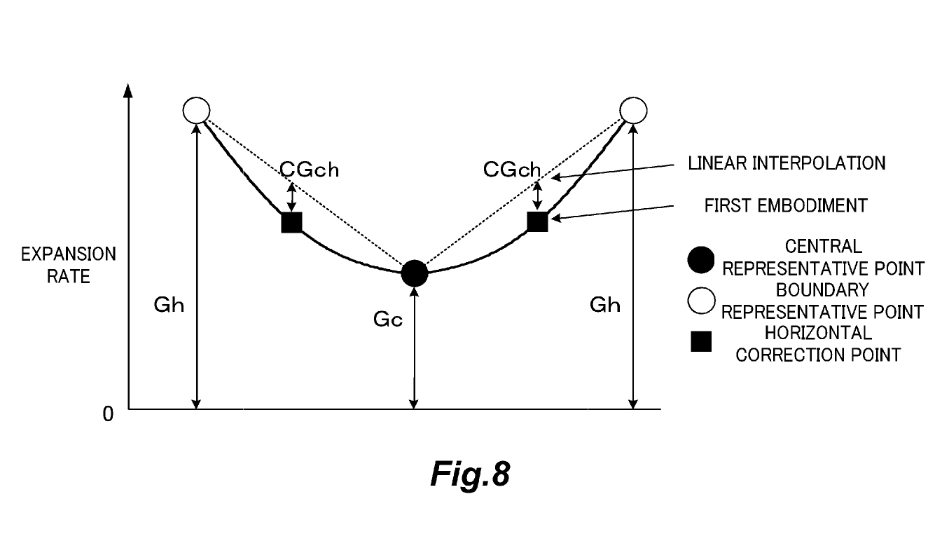

FIG. 8 shows a view explaining interpolation processing according to the first embodiment of the present invention. An example of FIG. 8 is one in the case where a pixel of interest is on a line connecting representative points to each other in the horizontal direction, in order to simplify the explanation thereof. As shown in FIG. 8, the expansion rate of a pixel on each of the representative points and the correction points is a value which is calculated based on an estimated brightness (i.e., a value which is obtained by dividing the standard lighting brightness by the estimated brightness). In a pixel between a representative point and a correction point, the expansion rate thereof becomes a value which is calculated by nonlinear interpolation using a curve which approximates a brightness distribution at the time when one of the light emission blocks is caused to emit light.

As described above, according to the present invention, the lighting brightnesses of only the representative points and the correction points are estimated, and the expansion rate of a pixel value for each pixel is calculated on a curve which approximates a distribution of lighting brightness based on those estimated brightnesses, as a result of which it is possible to carry out backlight brightness control at high precision with a small amount of calculation or computation.

### Second Embodiment

Hereinafter, an image display apparatus and a control method therefor according to a second embodiment of the present invention will be described with reference to the accompanying drawings. In the above-mentioned first embodiment, reference has been made to a calculation method in which a linear expansion rate and a nonlinear expansion rate are calculated individually, and an expansion rate for each pixel is calculated by adding the linear expansion rate and the nonlinear expansion rate to each other. In this second embodiment, however, reference will be made to a method in which an expansion rate for each pixel is directly calculated from a representative point expansion rate and a correction point expansion rate.

The functional configuration of the image processing apparatus according to the second embodiment is the same as that of the first embodiment.

The operations of a liquid crystal panel unit 101, a backlight unit 102, a characteristic amount detection unit 103, and a light emission amount calculation unit 104 are the same as those in the first embodiment.

The processing to calculate the expansion rates of pixel values at representative points and at a correction point located therebetween and the method to generate representative point expansion rate data, in an expansion rate calculation unit 105, are the same as those in the first embodiment. In the expansion rate calculation unit 105 of the second embodiment, an internal division ratio of the expansion rate of a correction point and the expansion rates of two representative points which are adjacent to the correction point is outputted as curve expansion rate data. Specifically, when the expansion rate of a correction point is represented by GC and the expansion rates of two representative points adjacent to the correction point are represented by GP1 and GP2, respectively, a corresponding curve expansion rate data CG is calculated by the following expression.

CG=(GC−GP1)/(GP2−GP1)−0.5 (6)

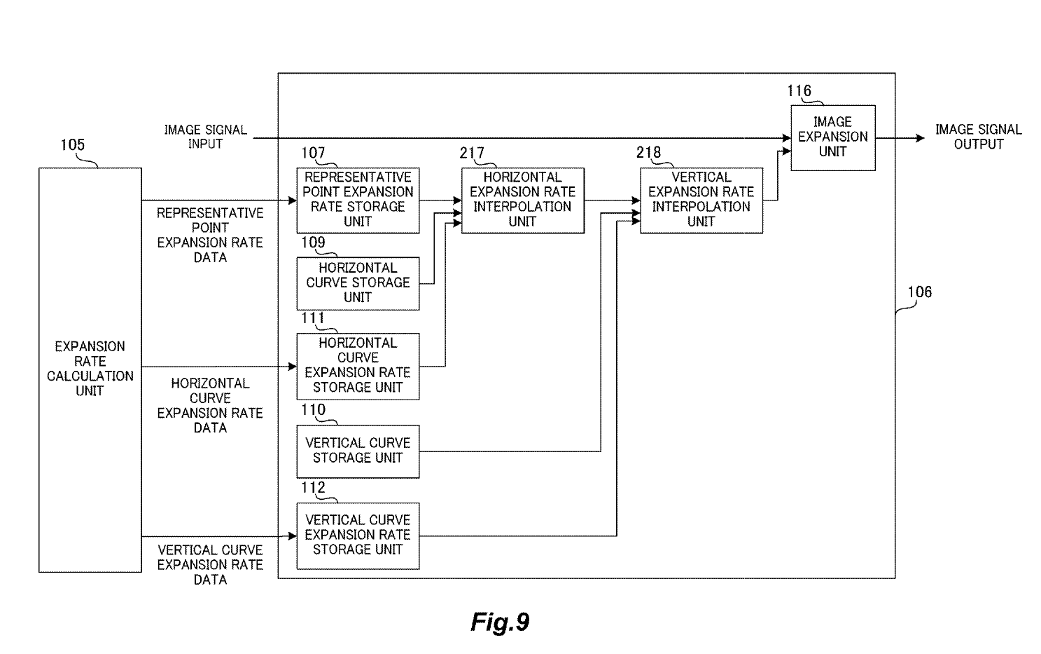

An image correction unit 106 converts an image signal inputted thereto based on the representative point expansion rate data and the curve expansion rate data calculated by the expansion rate calculation unit 105, and outputs an expanded image signal in which the pixel value of each pixel of the inputted image signal is expanded. An example of the functional configuration of the image correction unit 106 according to the second embodiment is shown in FIG. 9.

The image correction unit 106 is composed of a representative point expansion rate storage unit 107, a horizontal curve storage unit 109, a vertical curve storage unit 110, a horizontal curve expansion rate storage unit 111, a vertical curve expansion rate storage unit 112, a horizontal expansion rate interpolation unit 217, a vertical expansion rate interpolation unit 218, and an image expansion unit 116.

The operations of the representative point expansion rate storage unit 107, the horizontal curve storage unit 109, the vertical curve storage unit 110, the horizontal curve expansion rate storage unit 111, the vertical curve expansion rate storage unit 112, and the image expansion unit 116 are the same as those in the first embodiment.

The horizontal expansion rate interpolation unit 217 calculates and outputs horizontal interpolation expansion rates by interpolating the representative point expansion rate data based on the horizontal relative positions of a pixel of interest and representative points which are adjacent to the pixel of interest, horizontal curve data, and horizontal curve expansion rate data. Specifically, based on the following expressions, two horizontal interpolation expansion rates BGhc and BGh are obtained.

BGhc=Gc+(Gh−Gc)×(DPh/PWh+CGch×CVh) (7)

BGh=Gv+(Ghv−Gv)×(DPh/PWh+CGh×CVh) (8)

Here, the definition of each variable is the same as that in the first embodiment, and is as shown in FIG. 7.

The vertical expansion rate interpolation unit 218 calculates and outputs vertical interpolation expansion rates by interpolating the horizontal interpolation expansion rates based on the vertical relative positions of the pixel of interest and the representative points which are adjacent to the pixel of interest, vertical curve data, and vertical curve expansion rate data. Specifically, based on the following expressions, the vertical interpolation expansion rate BGv is obtained.

$$BGv = BGhc + ( BGh - BGhc ) \times \{ \begin{matrix}( DPv / PWv + CGcv \times CVv ) \times ( 1 - DPh / PWh ) + \\ ( DPv / PWv + CGv \times CVv ) \times DPh / PWh\end{matrix} \} \qquad ( 9 )$$

Here, the definition of each variable is the same as that in the first embodiment, and is as shown in FIG. 7. Here, when the expression (9) is transformed by using an expression of ΔBGh=(BGh−BGhc), the following result is obtained.

$$BGv = BGhc + Δ BGh \times DPv / PWv + Δ BGh \times CVv \times \{ \begin{matrix}CGcv \times ( 1 - DPh / PWh ) + \\ CGv \times DPh / PWh\end{matrix} \} \qquad ( 10 )$$

In expression (10) above, the second term represents the part of linear interpolation, and the third term represents the part of nonlinear interpolation.

The vertical interpolation expansion rate BGv calculated in the above manner becomes an expansion rate for each pixel. Here, note that in this embodiment, an example has been shown in which the processing of the vertical expansion rate interpolation unit 218 is carried out after the processing of the horizontal expansion rate interpolation unit 217, but the order of processing may be reversed.

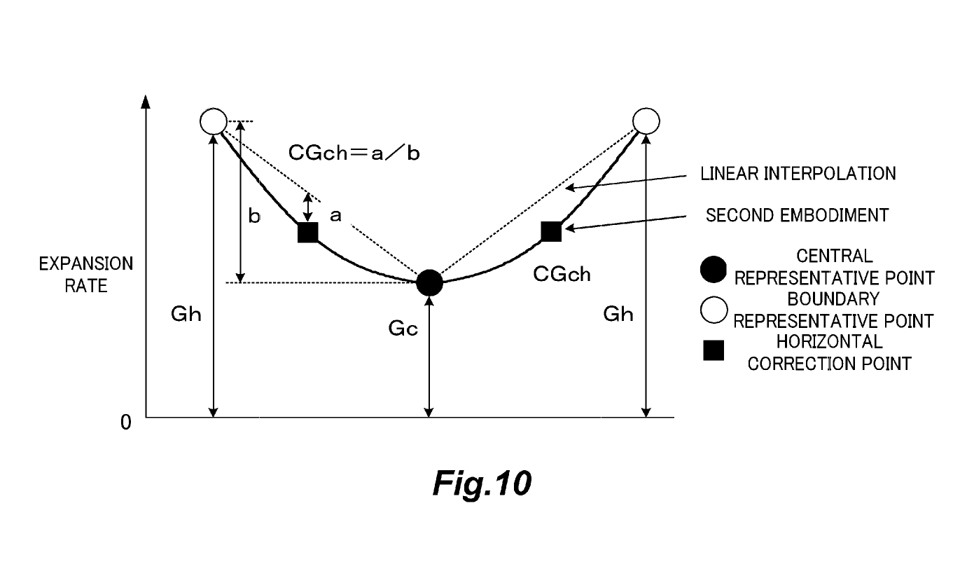

FIG. 10 shows a view explaining interpolation processing according to the second embodiment of the present invention. An example of FIG. 10 is one in the case where a pixel of interest is on a line connecting representative points to each other in the horizontal direction, in order to simplify the explanation thereof. As shown in FIG. 10, the expansion rates at pixels on representative points and correction points each become a value which is calculated based on an estimated brightness, similar to the first embodiment. In a pixel between a representative point and a correction point, the expansion rate thereof becomes a value which is interpolated in a smooth manner by nonlinear interpolation using a curve which approximates a brightness distribution at the time when one of the light emission blocks is caused to emit light.

As described above, according to this second embodiment, the same effects as in the first embodiment are obtained by a method of calculating an expansion rate for each pixel directly from a representative point expansion rate and a correction point expansion rate.

### Third Embodiment

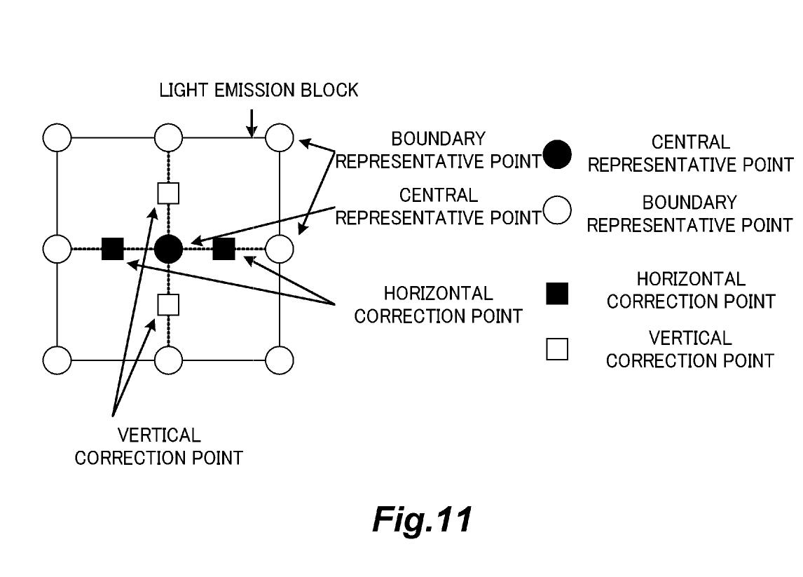

Hereinafter, an image display apparatus and a control method therefor according to a third embodiment of the present invention will be described with reference to the accompanying drawings. In the first embodiment and the second embodiment, reference has been made to a method to calculate an expansion rate for each pixel within one light emission block from representative point expansion rate data at nine points, and curve expansion rate data at twelve points. In this third embodiment, in order to reduce the amount of calculation operation for brightness estimation, reference will be made to a method to calculate an expansion rate for each pixel within one light emission block from representative point expansion rate data at nine points and curve expansion rate data at four points. FIG. 11 is a view explaining the relation between representative points and correction points according to the third embodiment of the present invention.

The functional configuration of the image processing apparatus according to the third embodiment is the same as that of the first embodiment.

The operations of a liquid crystal panel unit 101, a backlight unit 102, a characteristic amount detection unit 103, and a light emission amount calculation unit 104 are the same as those in the first embodiment.

The processing to calculate the expansion rates of pixel values at representative points and at a correction point located therebetween and the method to generate representative point expansion rate data and curve expansion rate data, in an expansion rate calculation unit 105, are the same as those in the first embodiment. However, in the first embodiment, in cases where a whole light emission block unit is divided into m×n pieces of individual light emission blocks, the number of correction points is (8×m×n+2×m+2×n), but in this third embodiment, the number of correction points is (4×m×n) and is decreased to half or less. For that reason, calculation processing for brightness estimation is reduced to a substantial extent.

An image correction unit 106 converts an image signal inputted thereto based on the representative point expansion rate data and the curve expansion rate data calculated by the expansion rate calculation unit 105, and outputs an expanded image signal in which the pixel value of each pixel of the inputted image signal is expanded. The functional configuration of the image correction unit 106 according to the third embodiment is the same as that of the first embodiment.

The image correction unit 106 is composed of a representative point expansion rate storage unit 107, a linear expansion rate interpolation unit 108, a horizontal curve storage unit 109, a vertical curve storage unit 110, a horizontal curve expansion rate storage unit 111, a vertical curve expansion rate storage unit 112, a horizontal nonlinear expansion rate interpolation unit 113, a vertical nonlinear expansion rate interpolation unit 114, an expansion rate addition unit 115, and an image expansion unit 116.

The operations of the representative point expansion rate storage unit 107, the linear expansion rate interpolation unit 108, the horizontal curve storage unit 109, the vertical curve storage unit 110, the expansion rate addition unit 115, and the image expansion unit 116 are the same as those in the first embodiment.

The horizontal curve expansion rate storage unit 111 of this third embodiment stores the curve expansion rate data of each correction point in the horizontal direction. The horizontal curve expansion rate storage unit 111 outputs horizontal curve expansion rate data of two horizontal correction points adjacent to a pixel of interest, based on the position of the pixel of interest. The two horizontal correction points adjacent to the pixel of interest are composed of a first horizontal correction point which is the nearest to the pixel of interest among the horizontal correction points of a light emission block to which the pixel of interest belongs, and a second horizontal correction point which is the nearest to the pixel of interest among the horizontal correction points of a light emission block which is adjacent to the light emission block to which the pixel of interest belongs on the opposite side of the first horizontal correction point in the vertical direction with respect to the pixel of interest. In other words, in this third embodiment, in order to obtain a horizontal nonlinear expansion rate of the pixel of interest, there are used not only horizontal curve expansion rate data of a horizontal correction point in a light emission block to which the pixel of interest belongs, but also horizontal curve expansion rate data of a horizontal correction point in a light emission block which is adjacent to the light emission block to which the pixel of interest belongs.

The horizontal nonlinear expansion rate interpolation unit 113 of this third embodiment carries out linear interpolation of the curve expansion rate data of the two correction points outputted from the horizontal curve expansion rate storage unit 111 based on the vertical relative positions of the pixel of interest. Here, in the case of this third embodiment, the vertical relative positions of the pixel of interest are a relative position of the pixel of interest with respect to a first central representative point of the light emission block to which the pixel of interest belongs, and a relative position of the pixel of interest with respect to a second central representative point of a light emission block which is adjacent to the light emission block to which the pixel of interest belongs on the opposite side of the first central representative point in the vertical direction with respect to the pixel of interest. Accordingly, the number of pixels 2×PWv between the adjacent central representative points is used, instead of using the number of pixels PWv between adjacent representative points in the first embodiment. Then, the horizontal nonlinear expansion rate interpolation unit 113 multiplies the horizontal curve data outputted from the horizontal curve storage unit 109 by the interpolated expansion rate data, and outputs it as a horizontal nonlinear expansion rate. Specifically, when the number of vertical pixels from the central representative point to the pixel of interest is represented by DPv, the number of pixels between the representative points in the vertical direction is represented by PWv, and the horizontal curve data is represented by CVh, the horizontal nonlinear expansion rate Gnlh is obtained from the following expression.

Gnlh=CVh×((1−0.5×DPv/PWv)×CGch0+0.5×DPv/PWv×CGch1) (11)

Here, CGch0 is the horizontal curve expansion rate data of the light emission block to which the pixel of interest belongs, and CGch1 is the horizontal curve expansion rate data of the adjacent light emission block.

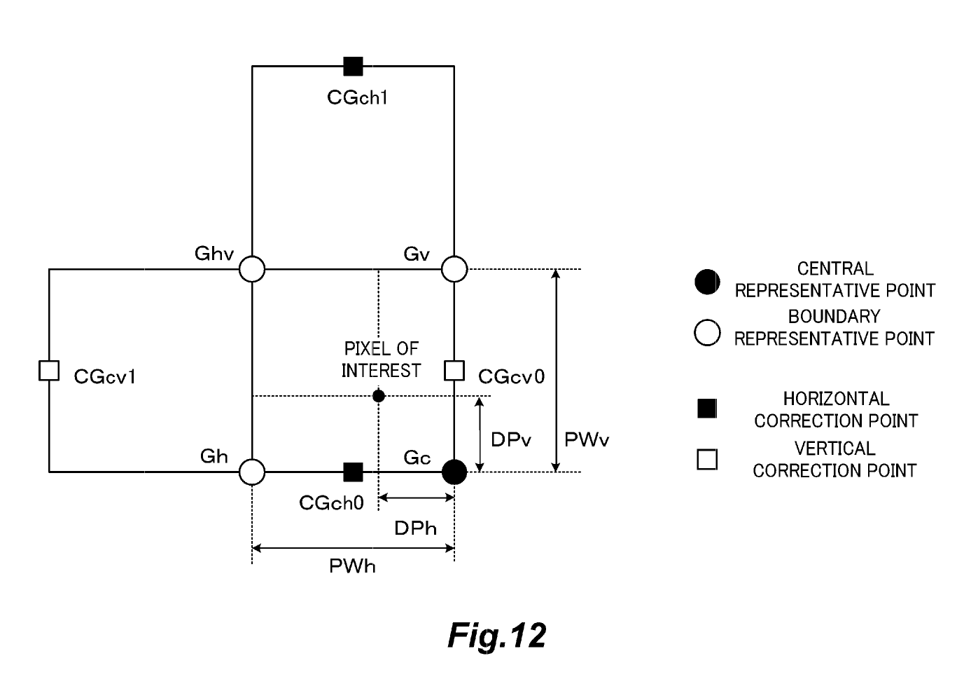

A view explaining the relation between the relative positions of the pixel of interest and the expansion rate data is shown in FIG. 12.

The vertical curve expansion rate storage unit 112 of this third embodiment stores the curve expansion rate data of each correction point in the vertical direction. The vertical curve expansion rate storage unit 112 outputs vertical curve expansion rate data of two vertical correction points adjacent to the pixel of interest, based on the position of the pixel of interest. The two vertical correction points adjacent to the pixel of interest are composed of a first vertical correction point which is the nearest to the pixel of interest among the vertical correction points of the light emission block to which the pixel of interest belongs, and a second vertical correction point which is the nearest to the pixel of interest among the vertical correction points of a light emission block which is adjacent to the light emission block to which the pixel of interest belongs on the opposite side of the first vertical correction point in the horizontal direction with respect to the pixel of interest. In other words, in this third embodiment, in order to obtain a vertical nonlinear expansion rate of the pixel of interest, there are used not only vertical curve expansion rate data of a vertical correction point in a light emission block to which the pixel of interest belongs, but also vertical curve expansion rate data of a vertical correction point in a light emission block which is adjacent to the light emission block to which the pixel of interest belongs.

The vertical nonlinear expansion rate interpolation unit 114 of this third embodiment carries out linear interpolation of the vertical curve expansion rate data of the two correction points outputted from the vertical curve expansion rate storage unit 112 based on the horizontal relative positions of the pixel of interest. Here, in the case of this third embodiment, the horizontal relative positions of the pixel of interest are a relative position of the pixel of interest with respect to the first central representative point of the light emission block to which the pixel of interest belongs, and a relative position of the pixel of interest with respect to a second central representative point of a light emission block which is adjacent to the light emission block to which the pixel of interest belongs on the opposite side of the first central representative point in the horizontal direction with respect to the pixel of interest. Accordingly, the number of pixels 2×PWh between the adjacent central representative points is used, instead of using the number of pixels PWh between adjacent representative points in the first embodiment. Then, the vertical nonlinear expansion rate interpolation unit 114 multiplies the vertical curve data outputted from the vertical curve storage unit 110 by the interpolated expansion rate data, and outputs it as a vertical nonlinear expansion rate. Specifically, when the number of horizontal pixels from the central representative point to the pixel of interest is represented by DPh, the number of pixels between the representative points in the horizontal direction is represented by PWh, and the vertical curve data is represented by CVv, the vertical nonlinear expansion rate Gnlv is obtained from the following expression.

$$Gnlv = CVv \times ( \begin{matrix}( 1 - 0.5 \times DPh / PWh ) \times CGcv 0 + \\ 0.5 \times DPh / PWh \times CGcv 1\end{matrix} ) \qquad ( 12 )$$

Here, as shown in FIG. 12, CGcv0 is the vertical curve expansion rate data of the light emission block to which the pixel of interest belongs, and CGcv1 is the vertical curve expansion rate data of the adjacent light emission block.

As described above, according to this third embodiment, by reducing the number of correction points, it is possible to carry out image correction based on brightness estimation of the representative points and the correction points, with a smaller amount of calculation operation than that in the first embodiment.

### Fourth Embodiment

Hereinafter, an image display apparatus and a control method therefor according to a fourth embodiment of the present invention will be described with reference to the accompanying drawings. In the first embodiment, an example has been shown in which an expansion rate for each pixel is interpolated by the use of a set of horizontal curve data and vertical curve data. However, in cases where the distribution of lighting brightness varies to a large extent with the positions of the light emission blocks, such as a light emission block at an edge of a screen, a light emission block at the middle of the screen, etc., it is better to use curve data suitable for them. In this fourth embodiment, there is shown an example in which an appropriate curve is selected from among a plurality of kinds of curves, according to the position of an image, and an expansion rate for each pixel is interpolated by using data of the curve thus selected.

The functional configuration of the image processing apparatus according to the fourth embodiment is the same as that of the first embodiment.

The operations of a liquid crystal panel unit 101, a backlight unit 102, a characteristic amount detection unit 103, and a light emission amount calculation unit 104 are the same as those in the first embodiment.

The functional configuration of an image correction unit 106 according to the fourth embodiment is the same as that of the first embodiment.

The operations of a representative point expansion rate storage unit 107, a linear expansion rate interpolation unit 108, a horizontal curve expansion rate storage unit 111, a vertical curve expansion rate storage unit 112, a horizontal nonlinear expansion rate interpolation unit 113, a vertical nonlinear expansion rate interpolation unit 114, an expansion rate addition unit 115, and an image expansion unit 116 are the same as those in the first embodiment.

A horizontal curve storage unit 109 stores two kinds of curve data which include curve data to be applied to an image in the vicinity of the horizontal center of a screen, and curve data to be applied to an image in the vicinity of a horizontal edge of the screen. Then, in cases where a pixel of interest is in the vicinity of a screen horizontal edge, the horizontal curve storage unit 109 selects and outputs the curve data to be applied to an image in the vicinity of a horizontal edge of the screen, according to the horizontal position of the pixel of interest, whereas in cases where the pixel of interest is in a position other than that, the horizontal curve storage unit 109 selects and outputs the curve data to be applied to an image in the vicinity of the horizontal center of the screen.

A vertical curve storage unit 110 stores two kinds of curve data which include curve data to be applied to an image in the vicinity of the vertical center of the screen, and curve data to be applied to an image in the vicinity of a vertical edge of the screen. Then, in cases where a pixel of interest is in the vicinity of a screen vertical edge, the vertical curve storage unit 110 selects and outputs the curve data to be applied to an image in the vicinity of a vertical edge of the screen, according to the vertical position of the pixel of interest, whereas in cases where the pixel of interest is in a position other than that, the vertical curve storage unit 110 selects and outputs the curve data to be applied to an image in the vicinity of the vertical center of the screen.

As described above, according to this fourth embodiment, an appropriate curve is selected from among a plurality of kinds of curves, according to the position of an image, and an expansion rate for each pixel is interpolated by using data of the curve thus selected, as a result of which it is possible to mitigate the reduction in interpolation accuracy of an expansion rate according to the position of an image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-81183, filed on Mar. 30, 2012, which is hereby incorporated by reference herein in its entirety.

What is claimed is:

1. An image display apparatus comprising:
a lighting apparatus composed of a plurality of light emission blocks, the emissions of lights of which are able to be controlled independently of one another;
a display panel configured to control the transmittances of the lights from said lighting apparatus for each pixel;
a first calculation unit configured to calculate an amount of light emission for each light emission block based on an image signal;
a storage unit configured to store representative point brightness data for each case where each of said plurality of light emission blocks is caused to emit light, the representative point brightness data is data of brightnesses in a plurality of representative points provided in each of said plurality of light emission blocks at the time when only one of said light emission blocks is caused to emit light with a predetermined amount of light emission, and the storage unit is also configured to store brightness distribution data which is data showing brightness distribution in individual positions between mutually adjacent representative points of the one of said light emission blocks at the time when only the one of said light emission blocks is caused to emit light with the predetermined amount of light emission;
a second calculation unit configured to calculate an amount of correction for correcting a pixel value of a pixel in each of positions which correspond to the individual representative points of said plurality of light emission blocks, respectively, based on the amount of light emission for each of said light emission blocks and the representative point brightness data of said plurality of light emission blocks, and the second calculation unit is configured to calculate an amount of correction for correcting a pixel value of each of pixels other than those at said representative points based on the amount of correction for correcting the pixel value of the pixel in each of the positions which correspond to the individual representative points, respectively, and said brightness distribution data; and
a correction unit configured to output to said display panel a correction image signal in which a pixel value of each pixel of an image signal inputted thereto has been corrected by the use of the amount of correction calculated by said second calculation unit.

2. The image display apparatus as set forth in claim 1, wherein
said second calculation unit calculates an amount of correction for correcting a target pixel by a nonlinear interpolation operation based on a relative positional relation between the target pixel of which the amount of correction is calculated and a pixel which corresponds to a representative point, an amount of correction for correcting a pixel value of a pixel in a position corresponding to each representative point, and said brightness distribution data.

3. The image display apparatus as set forth in claim 1, wherein
said brightness distribution data is data of a difference between a brightness at each position between representative points of one light emission block at the time of causing only said one light emission block to emit light with a predetermined amount of light emission, and a brightness at each position between said representative points in cases where a brightness change between said representative points is assumed to be linear.

4. The image display apparatus as set forth in claim 1, wherein
said first calculation unit calculates an amount of light emission of each light emission block according to a characteristic amount of an image signal in a region which corresponds to each light emission block.

5. The image display apparatus as set forth in claim 1, wherein
said first calculation unit calculates an estimated value of brightness at each representative point at the time of causing each light emission block to emit light with an amount of light emission which is calculated based on a characteristic amount of an image signal in a region corresponding to each light emission block, based on said amount of light emission and said representative point brightness data, and the first calculation unit also corrects the amount of light emission calculated for said each light emission block, based on the estimated value of brightness at said each representative point and a target value of brightness at each representative point calculated based on the image signal, and then outputs the amount of light emission thus corrected to said lighting apparatus.

6. The image display apparatus as set forth in claim 1, wherein
said representative points include a plurality of first representative points and a plurality of second representative points, said second representative points being arranged between said first representative points; and
said second calculation unit calculate an amount of correction for correcting a pixel value of a pixel in each of positions which correspond to the first individual representative points and the second individual representative points, respectively, based on the amount of light emission for each light emission block and the representative point brightness data, and the second calculation unit also calculates an amount of correction for a target pixel by means of a linear interpolation operation based on a relative positional relation of the target pixel of which the amount of correction is calculated and the first representative points, and the amounts of correction which correspond to the first representative points, respectively, and a nonlinear interpolation operation based on a relative positional relation of the target pixel of which the amount of correction is calculated and the first representative points, the amounts of correction which correspond to the second representative points, respectively, and the brightness distribution data.

7. The image display apparatus as set forth in claim 6, wherein
said first representative points are a point at which a peak is formed and a point which becomes an inflection point, or a point in the vicinity of those points, in a brightness distribution at the time of causing only one light emission block to emit light with a predetermined amount of light emission.

8. The image display apparatus as set forth in claim 6, wherein
each of said light emission block has a square shape or a rectangular shape; and
said first representative points include four vertices and a central point of each light emission block, and intermediate points between said vertices which are arranged on four sides of each light emission block.

9. The image display apparatus as set forth in claim 6, wherein
each of said light emission block has a square shape or a rectangular shape; and
said second representative points include an intermediate point which is arranged on a line connecting between two first representative points adjacent to each other in a horizontal direction, and an intermediate point which is arranged on a line connecting between two first representative points adjacent to each other in a vertical direction.

10. The image display apparatus as set forth in claim 6, wherein
each of said light emission block has a square shape or a rectangular shape; and
said second representative points include an intermediate point which is arranged on a line connecting between a first representative point located at the center of each light emission block and another first representative point adjacent thereto in a horizontal direction, and an intermediate point which is arranged on a line connecting between the first representative point located at the center of each light emission block and another first representative point adjacent thereto in a vertical direction.

11. The image display apparatus as set forth in claim 1, wherein
said storage unit stores a plurality of kinds of brightness distribution data; and
said second calculation unit selects a kind of brightness distribution data to be used for calculation of an amount of correction according to the position of a target pixel for which an amount of correction is calculated.

12. A control method for an image display apparatus which includes:
a lighting apparatus composed of a plurality of light emission blocks, the emissions of lights of which are able to be controlled independently of one another; and
a display panel configured to control the transmittances of the lights from said lighting apparatus for each pixel;
said method comprising:
a first calculation step of calculating an amount of light emission for each light emission block based on an image signal;
a step of reading in representative point brightness data and brightness distribution data from a storage unit which is configured to store the representative point brightness data for each case where each of said plurality of light emission blocks is caused to emit light, the representative point brightness data is data of brightnesses in predetermined representative points provided in each of said plurality of light emission blocks at the time when only one of said light emission blocks is caused to emit light with a predetermined amount of light emission, and which is also configured to store the brightness distribution data which is data showing brightness distribution in individual positions between mutually adjacent representative points of the one of said light emission blocks at the time when only the one of said light emission blocks is caused to emit light with the predetermined amount of light emission;
a second calculation step of calculating an amount of correction for correcting a pixel value of a pixel in each of positions which correspond to the individual representative points of said plurality of light emission blocks, respectively, based on the amount of light emission for each of said light emission blocks and the representative point brightness data of said plurality of light emission blocks, and calculating an amount of correction for correcting a pixel value of each of pixels other than those at said representative points based on the amount of correction for correcting the pixel value of the pixel in each of the positions which correspond to the individual representative points, respectively, and said brightness distribution data; and
a correction step of outputting to said display panel a correction image signal in which a pixel value of each pixel of an image signal inputted thereto is corrected by the use of the amount of correction calculated in said second calculation step.

13. The control method for the image display apparatus as set forth in claim 12, wherein
in the second calculation step, an amount of correction for correcting a target pixel is calculated by a nonlinear interpolation operation based on a relative positional relation between the target pixel of which the amount of correction is calculated and a pixel which corresponds to a representative point, an amount of correction for correcting a pixel value of a pixel in a position corresponding to each representative point, and said brightness distribution data.

14. The control method for the image display apparatus as set forth in claim 12, wherein
said brightness distribution data is data of a difference between a brightness at each position between representative points of one light emission block at the time of causing only said one light emission block to emit light with a predetermined amount of light emission, and a brightness at each position between said representative points in cases where a brightness change between said representative points is assumed to be linear.

15. The control method for the image display apparatus as set forth in claim 12, wherein
in the second calculation step, an amount of light emission of each light emission block is calculated according to a characteristic amount of an image signal in a region which corresponds to each light emission block.

16. The control method for the image display apparatus as set forth in claim 12, wherein
in the first calculation step, an estimated value of brightness at each representative point at the time of causing each light emission block to emit light with an amount of light emission which is calculated based on a characteristic amount of an image signal in a region corresponding to each light emission block is calculated based on said amount of light emission and said representative point brightness data, and in the first calculation step, the amount of light emission calculated for said each light emission block is corrected based on the estimated value of brightness at said each representative point and a target value of brightness at each representative point calculated based on the image signal, and then the amount of light emission thus corrected is output to said lighting apparatus.

17. The control method for the image display apparatus as set forth in claim 12, wherein
said representative points include a plurality of first representative points and a plurality of second representative points, said second representative points being arranged between said first representative points; and
in the second calculation step, an amount of correction for correcting a pixel value of a pixel in each of positions which correspond to the first individual representative points and the second individual representative points is calculated respectively based on the amount of light emission for each light emission block and the representative point brightness data, and in the second calculation step, an amount of correction for a target pixel is calculated by means of a linear interpolation operation based on a relative positional relation of the target pixel of which the amount of correction is calculated and the first representative points, and the amounts of correction which correspond to the first representative points, respectively, and a nonlinear interpolation operation based on a relative positional relation of the target pixel of which the amount of correction is calculated and the first representative points, the amounts of correction which correspond to the second representative points, respectively, and the brightness distribution data.

18. The control method for the image display apparatus as set forth in claim 17, wherein
said first representative points are a point at which a peak is formed and a point which becomes an inflection point, or a point in the vicinity of those points, in a brightness distribution at the time of causing only one light emission block to emit light with a predetermined amount of light emission.

19. The control method for the image display apparatus as set forth in claim 17, wherein
each of said light emission block has a square shape or a rectangular shape; and
said first representative points include four vertices and a central point of each light emission block, and intermediate points between said vertices which are arranged on four sides of each light emission block.

20. The control method for the image display apparatus as set forth in claim 17, wherein
each of said light emission block has a square shape or a rectangular shape; and
said second representative points include an intermediate point which is arranged on a line connecting between two first representative points adjacent to each other in a horizontal direction, and an intermediate point which is arranged on a line connecting between two first representative points adjacent to each other in a vertical direction.

21. The control method for the image display apparatus as set forth in claim 17, wherein
each of said light emission block has a square shape or a rectangular shape; and
said second representative points include an intermediate point which is arranged on a line connecting between a first representative point located at the center of each light emission block and another first representative point adjacent thereto in a horizontal direction, and an intermediate point which is arranged on a line connecting between the first representative point located at the center of each light emission block and another first representative point adjacent thereto in a vertical direction.

22. The control method for the image display apparatus as set forth in claim 12, wherein
said storage unit stores a plurality of kinds of brightness distribution data; and
in the second calculation step, a kind of brightness distribution data to be used for calculation of an amount of correction is selected according to the position of a target pixel for which an amount of correction is calculated.
